(19) United States
(12) Patent Application Publication
(10) Pub. No.: US 2010/0107439 A1
(43) Pub. Date: May 6, 2010

(54) High efficiency drier

(75) Inventors: Steve D. Shivvers, Prole, IA (US); Lloyd E. Lerew, Dillsburg, PA (US)

Correspondence Address: LAW OFFICE OF JOHN C. MCMAHON, P.O. BOX 30069, KANSAS CITY, MO, 64112, US

(73) Assignee: Tri-Phase Drying Technologies, LLC, an Iowa Limited Liability Company, Norwalk, IA (US)

(21) Appl. No.: 12/589,940

(22) Filed: Oct. 30, 2009

Related U.S. Application Data
(60) Provisional application No. 61/198,036, filed on Oct. 31, 2008.

(51) Int. Cl. F26B 3/00; F26B 19/00; F26B 25/00

(52) U.S. Cl. 34/477; 34/504; 34/219; 34/86; 34/236

(57) ABSTRACT

A drier for drying wet material includes a drying chamber receiving material to be dried. Heating fluid is flowed generally overall concurrently with the material through at least a portion of the chamber and drying fluid is flowed generally overall countercurrently relative to the material through at least part of the chamber.

### CROSS-REFERENCE TO RELATED APPLICATIONS

This application claims the benefit of U.S. Provisional Patent Application Ser. No. 61/198,036, filed Oct. 31, 2008 and incorporated by reference herein.

### BACKGROUND OF THE INVENTION

The present invention is directed to improvements in driers and methods of drying used to dry various materials, including newly harvested grain, wood pellets, and particulate materials of all types and, in particular, to driers that utilize fluid to heat the material, cool and dry the material with generally overall countercurrent air flow and recover and utilize a comparatively high percentage of the energy used in the drying process.

The drying industry is very large and utilizes significant amounts of both fossil fuels and electricity to dry various materials. While the grain industry is not the only industry that requires significant drying, it is indicative of the problems that exist. Just the United States corn crop amounts to over nine billion bushels annually. At least part of the moisture present at harvest must be removed in order to allow the grain to be stored without significant loss due to mold, mildew and rot, all caused by excess retained moisture.

In theory, each pound of water removed from the grain has a latent heat of vaporization of about 1160 British thermal units (Btu) per pound. In an extremely effective drier system, the drier could import exactly this theoretical amount of energy per pound of water to be removed from the material to be dried. In reality, the material to be dried also takes on sensible heat and rises in temperature, the flow of heated air or the like is often not uniform, the material is often heated more on one side of the drier than the other, etc., such that the efficiency of all types of conventional driers is comparatively low. For example, conventional cross flow grain driers usually require approximately more than 2000 Btu per pound of water removed versus the theoretical amount of 1160 Btu per pound.

Because just the corn industry in the United States consumes approximately 900 million gallons of propane and over 3200 million kilowatt-hours of electricity per year just to dry the corn and because this produces nearly two million tons of carbon dioxide exhaust gases per year due to the burning of fossil fuels, it is seen that any improvement in drying efficiency can amount to significant savings in fuel, energy and emissions. Corn is only one type of grain that must be dried. Further, there are many other solids, semi-solids and initially liquid compositions that are dried each year at considerable costs in terms of fuel, energy and undesired emissions due to combustion of the fuels.

It is further noted that for some materials the manner of drying is important to prevent excessive shock to the product being dried and/or to reduce inconsistency in the dried material. For example, grain kernels can be cracked by cooling or heating too quickly, which can lead to degradation of the grain. While conventional driers may produce a chosen average moisture content, the content may not be consistent throughout the grain. Consequently, problems are encountered generally in many types of conventional grain cross flow driers, where the grain is heated and dried by air passing perpendicularly to the flow of the grain. In such driers, the grain on one side of the drier that first encounters the heated air is overly dried and may be dried too quickly or cooled too quickly so as to cause cracking and the grain on the opposite or on the air discharge side tends to be too wet.

In some circumstances, it is also desirable to provide a closed recycle system for gas used in the drying process to reduce dust or other undesirable emissions.

### SUMMARY OF THE INVENTION

A high efficiency drier for drying materials, especially particulate material of all types, that recovers and reutilizes a substantial portion of the heat used in the drying process, such that only a comparatively small amount of makeup heat must be added to the process.

The drier includes a generally enclosed drying chamber, a heating fluid recirculation system, a drying fluid circulation system, a regenerator, and a makeup heater.

The drying chamber of this application is preferably a vertical column through which material to be dried passes due to gravity under control of a discharge mechanism. The various embodiments include multiple bags within the chamber through which the material passes sequentially. In some of the embodiments the bays are in combined heating and drying regions. In other embodiments bays are in separate heating and drying regions. The heating fluid enters the drying chamber in a hot state and the recirculation system circulates the heating fluid sequentially through each heating compartment or bay along the path of the material to be dried. The heating fluid exits the drying chamber in a comparatively cool state and is conveyed by the heating fluid recirculation system to the regenerator. The heating fluid is preheated in the regenerator by heat exchange with the drying fluid. The regenerator is preferably a shell and tube heat exchanger; however, in some embodiments the regenerator is a heat pump system or a primary tube and shell heat exchanger with an auxiliary heat pump system. It is foreseen that other types of heat transfer regenerators could be used in the various embodiments. The heating fluid can be gaseous (such as air, nitrogen or the like) or liquid (such as oil); however, the heating fluid is often preferably water. In some embodiments a portion of the heating may be accomplished by the heat pump system used to preheat the material to be dried or selected early heating regions.

The makeup heater provides heat to the heating fluid to raise the temperature thereof to a preselected range or specific temperature prior to entering the drying chamber. Preferably, the heating fluid recirculation system returns the heating fluid from the regenerator to the drying chamber through the makeup heater; however, heat can be added at other locations such as directly to the material prior to entering the drying chamber, especially by a heat pump system withdrawing residual heat from gas exiting a primary heat exchanger.

The drying fluid circulation system circulates a drying fluid sequentially through the drying bays generally in reverse order or counterflow to the flow of material through the drying bays. Preferably, the drying fluid is air and further preferably the drying fluid is ambient air, although other fluids such as nitrogen may be used, if necessitated by the processing needs. The drying fluid must be able to absorb, carry, or take up moisture released by the material. With air as the drying fluid, the air becomes heated as it passes though the material previously heated in the heating regions or by the heating fluid system and becomes saturated or at least partially saturated with moisture. In some embodiments the heating fluid bypasses the drying regions and the drying fluid preferably at least in part bypasses or substantially bypasses the heating regions. In other embodiments heating and drying occur in the same bays or in some common bays.

The drying fluid enters the drying chamber in a cool preferably comparatively dry state and exits the drying chamber in a warm wet state. The terms dry and wet are not intended to indicate relative humidity or saturation at a particular temperature, but rather the total moisture content of the drying fluid entering and exiting the drying chamber. That is, the drying fluid contains more total moisture when exiting the drying chamber than when entering the drying chamber. Upon exiting the drying chamber, the drying fluid is transported by the drying fluid circulation system to the regenerator wherein the drying fluid in a warm state transfers heat to the heating fluid that enters the regenerator in a comparatively cool state. In certain embodiments the drying fluid upon exiting the primary regenerator may be passed through a secondary or auxiliary heat pump system to withdraw more heat to transfer to the material being dried. Condensation that collects due to the cooling of the drying fluid in the regenerator is collected and discharged.

The drying fluid is most often discharged from the regenerator into the air. However, in some instances the drying fluid may carry too much pollution, such as dust, or may be too expensive to waste and, in such situations, the drying fluid exiting the regenerator may be returned to the drying chamber. In such circumstances a chiller with a condensate drain may be required to chill the drying fluid returning to the drying chamber a small amount to assure that the temperature of the drying fluid is decreased to or maintained at a preselected temperature, such as 70° F., prior to reintroduction to the drying chamber. If the temperature of the recycled drying fluid is not reduced between the regenerator and the drying chamber, the drying potential of the chamber may be markedly decreased. Chilling may be through a refrigeration unit, a heat pump or the like. A heat pump, when used for this purpose, has the advantage of recapturing the energy removed from the recycled drying fluid for reintroduction of the heat to the heating fluid in the region between the regenerator and the makeup heater or to the material to be dried in a preheater prior to the first heating compartment or elsewhere in the drier.

The drying fluid flows generally overall counter currently to the flow of material in the drier. However, the drying fluid can be in countercurrent, concurrent, cross, mixed or other flow relative to the material in each individual drying regions or compartment.

The drier and drying process of the invention are especially advantageous in consistently and uniformly removing moisture with low stress from a material with a minimal input of heat. Further, the drier and process provide the advantage of being adaptable to a closed system to reduce undesirable emissions to the air.

### OBJECTS AND ADVANTAGES OF THE INVENTION

Therefore, the objects of the invention are: to provide a drier that is highly efficient with respect to use of energy; to provide such a drier wherein heat is recovered and reused; to provide such a drier wherein heating fluid and drying fluid is flowed concurrently, countercurrently, cross, mixed or otherwise through heating compartments and/or drying compartments; to provide such a drier wherein drying fluid exiting the drier is utilized to preheat heating fluid entering the drier; to provide such a drier that is comparatively inexpensive to operate, easy to use and especially well adapted for the intended usage thereof and to provide a process for effectively utilizing such a drier.

Other objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is a partially schematic front elevational view of a first drier in accordance with the present invention.

FIG. 2 is an enlarged cross sectional view of a drying chamber of the first drier, taken along line 2-2 of FIG. 1, with portions broken away to show detail thereof.

FIG. 3 is an enlarged cross sectional view of the drying chamber of the first drier, taken along line 3-3 of FIG. 2.

FIG. 4 is a partially schematic front elevational view of a second drier in accordance with the present invention.

FIG. 5 is an enlarged cross sectional view of a drying chamber of the second drier, taken along line 5-5 of FIG. 4.

FIG. 6 is an enlarged cross sectional view of the drying chamber of the second drier, taken along line 6-6 of FIG. 5.

FIG. 7 is a partially schematic front elevational view of a third drier in accordance with the present invention.

FIG. 8 is an enlarged cross sectional view of a drying chamber of the third drier, taken along line 8-8 of FIG. 7.

FIG. 9 is an enlarged cross sectional view of the drying chamber of the third drier, taken along line 9-9 of FIG. 8.

FIG. 10 is a partially schematic front elevational view of a fourth drier in accordance with the present invention.

FIG. 11 is a partially schematic front elevational view of a fifth drier in accordance with the present invention.

FIG. 12 is a partially schematic front elevational view of a sixth drier in accordance with the present invention.

FIG. 13 is a partially schematic front elevational view of a seventh drier in accordance with the present invention.

FIG. 14 is a partially schematic front elevational view of an eighth drier in accordance with the present invention.

FIG. 15 is a partially schematic front elevational view of a ninth drier in accordance with the present invention.

FIG. 16 is a schematic drawing showing flow that is generally countercurrent, but sectionally concurrent.

FIG. 17 is a schematic drawing showing flow that is generally countercurrent, but sectionally cross flow.

FIG. 18 is a schematic drawing showing flow that is generally countercurrent, but that is sectionally mixed flow.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

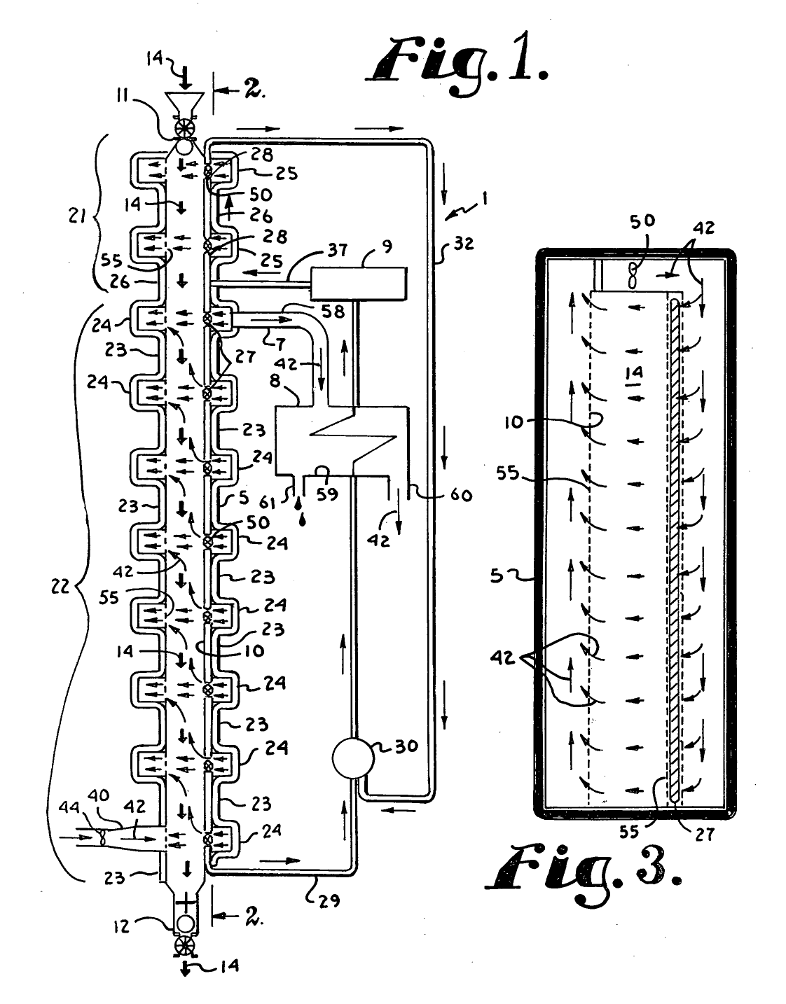

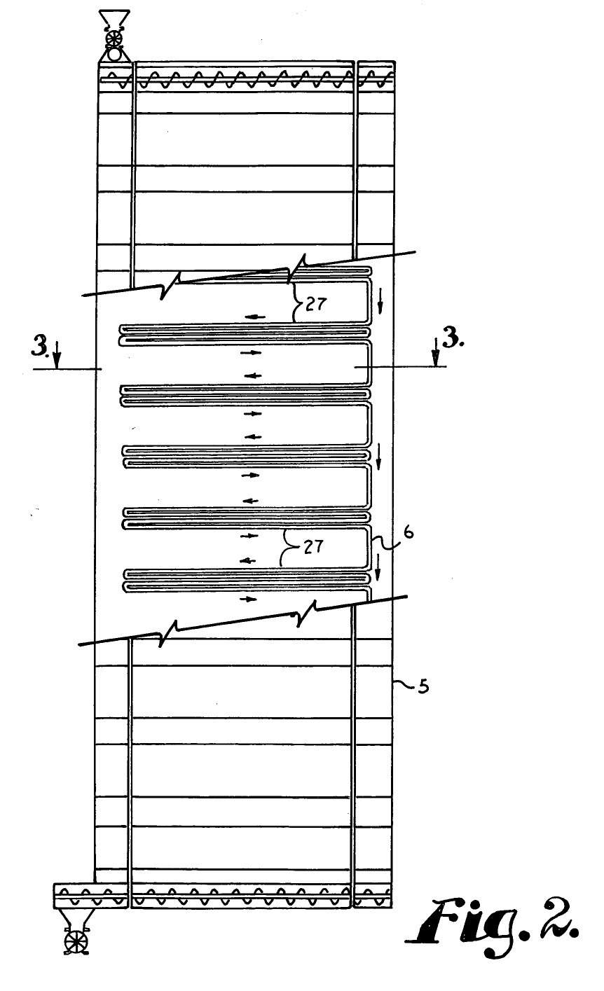

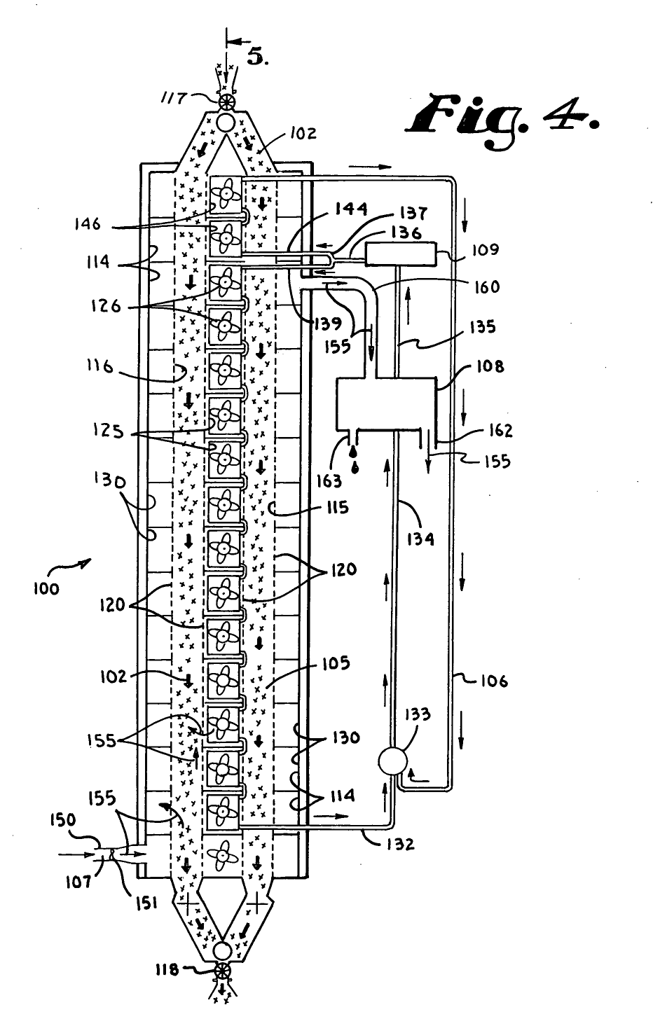

Shown in FIGS. 1 to 3 is a drier in accordance with the present invention that is generally indicated by the reference numeral 1.

The drier 1 includes a drying chamber 5, a heating fluid recirculation system 6, a drying fluid circulation system 7, a regenerator 8 and a makeup heater 9.

The drying chamber 5 includes a vertical column 10 having an upper inlet end 11 and a lower outlet end 12. Material to be dried and generally indicated by downward directed arrows labeled 14 throughout the chamber 5 flows into the inlet end 11 and through the chamber 5 due to gravity and out the outlet end 12.

The chamber 5 includes an upper section 21 and a lower section 22. Both sections 21 and 22 are subdivided into equal numbers of regions that in the lower section 22 are alternatively drying regions 23 and heating regions 24. The upper section 21 is divided also into heating regions 25 and steeping regions 26. It is foreseen that vibratory mechanisms rotating paddles and the like may be located in the vertical column to aid the flow of material therethrough.

The heating fluid recirculation system 6 includes or conduit or piping 27 located within each heating region 24 and conduit or piping 28 located in each heating region 25 and positioned so as to be adjacent to the material 14 therein. A discharge conduit 29 with a pump 30 joins the conduit 27 with a tube side 31 of the regenerator 8. A second conduit 32 flow connects the conduit 28 with the pump 30. The regenerator 8 is flow connected with the makeup heater 9 by a conduit 35 and the makeup heater 9 which in turn flow connects with the conduits 25 and 26 of the heating regions respectfully through conduit 37.

The drying fluid circulation system 7 includes an inlet 40 for drawing drying fluid identified by the reference arrow 42 throughout the drier 1 into the chamber 5 by operation of a blower or fan 44. In the drier 1 the drying fluid is circulated by blowers 50 in each heating region 24 and through the material 14 that is held in the central part of the column 10 by screens 55 in each heating region 24. Drying fluid 42, after generally flowing counter current to the material 14 in the lower section 21 and picking up moisture therein while becoming warmer, is discharged from the chamber 5 through an outlet conduit 58 which flow connects with a shell side 59 of the regenerator 8. The drying fluid 42 exits the regenerator 8 through an outlet 60. The shell side 59 of the regenerator 8 also collects condensate that is discharged through a drain 61. The drying fluid 42 flows generally counter current to the material in the lower section 22, but flows also in a mixed cross flow in each of the heating regions 24.

In the upper section 21 the drying fluid generally flows in cross flow past the heating conduits 27 to transfer heat from the heating fluid flowing counter currently to the material 14 in the upper section 21.

In this manner, the material 14 flows generally overall countercurrently with respect to the heating fluid in the upper section 21 and concurrently with the heating fluid through the lower section 22 while in the chamber 5, although it is foreseen that the actual segment of flow in each heating region may be concurrent, cross flow, countercurrent or mixed flow. The flow of drying fluid 42 overall is generally countercurrent to the flow of material 14 in the lower section 22, but is generally cross flow within each separate heating region 24. The drying fluid 42 exiting the chamber 5 is utilized to preheat the heating fluid in the regenerator 8 and makeup heat is added to the heating fluid in the makeup heater 9.

It is foreseen in some instances that drying fluid from the regenerator 8 may be recycled through a chiller by a conduit (now shown) and returned to the inlet 40 to maintain a generally uniform temperature of drying fluid 42 entering the chamber 5 while reusing the drying fluid 42. It is foreseen that a heat pump may be used instead of a heat exchanger for the regenerator or for a chiller with heat transferred from the heat pump to the heating fluid and/or directly to the material 14 to be dried.

It is foreseen that the regenerator used in any embodiment herein may be other than a shell and tube heat exchanger, and may be any type of exchangers that is capable of transferring heat from the drying fluid to the heating fluid function within the scope of the invention.

While a continuous counter flow process is described for the drying chamber and the regeneration systems in the embodiments described, it is foreseen that batch processes could be utilized using one or a series of sequential batch operations.

It is foreseen that in addition to gravity conveyance of the material to be dried through the chamber may be aided by other types of conveyance systems including, but not limited to augers, belts and the like. It is foreseen that the overall drying chamber can be of a wide variety of shapes and sizes so as to provide for the required flow of material to be dried.

While air and nitrogen are the most likely fluids to be used in a process of this type, it is foreseen that other fluids such as argon or the like may be used. Furthermore, while particular materials to be dried are generally mentioned herein, it is foreseen that a wide variety of materials may be dried, including particulates and other granular materials, powders, flakes, pastes, slurries, and solids in general. Such materials are not restricted to but may be represented by foodstuffs, such as grains, including corn, beans, dog food, mixes, meals and flours; chemicals such as clays, coals, sand; and processed materials, such as paper and the like.

It is foreseen that the drying chamber and the regenerator can be operated under vacuum or pressurized in certain embodiments with or without heating the material to be dried to higher temperature.

As used herein the phrase “substantially overall counter currently” with respect to flow of the material to be dried and/or the heating fluid relative to the drying fluid, means that both the material and heating fluid enter the chamber at or near one end and exit the chamber near at or near the other end and that the drying fluid enters the chamber at or near the exit of the material and exits at or near the entry of the material, but during travel through the chamber, segments or portions of the drying fluid may flow in cross flow, counter current flow, concurrent flow or mixed flow relative to the material and/or the heating. The term “near” does not mean exactly at one end, but rather closer to such end than the other end.

As used herein the phrase “substantially overall concurrently” with respect to flow of the heating fluid relative to the material to be dried, means that both enter the chamber near one end and exit the chamber near the opposite end but during travel through the chamber, segments or portions of the drying fluid may flow in cross flow, counter current flow, concurrent flow or mixed flow relative to the material.

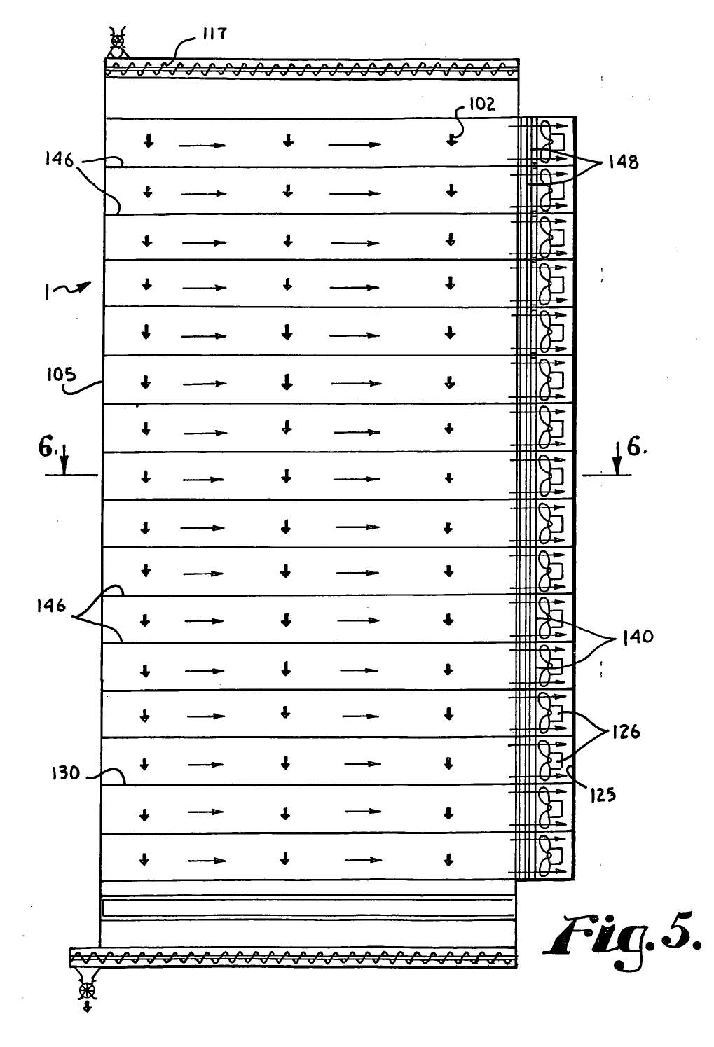

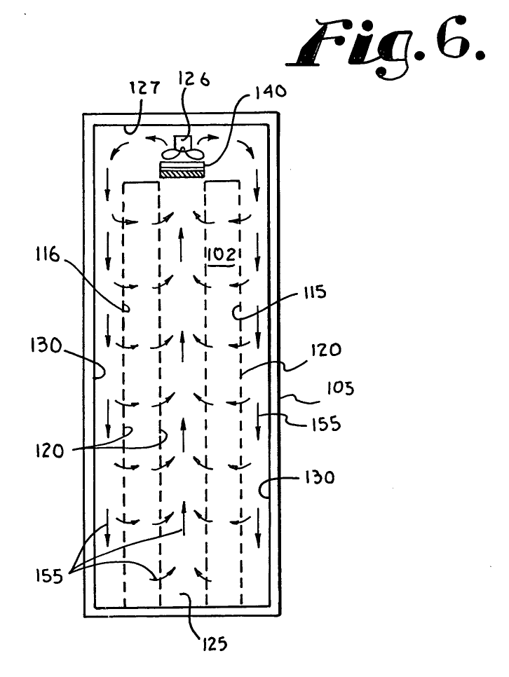

Illustrated in FIGS. 4 to 6 is a second drier in accordance with the present invention generally indicated by the reference numeral 100. The drier 100 is for drying a material indicated by x's and thick arrows and is indicated by the reference numeral 102. The drier 100 comprises a vertically aligned drying chamber 105, a heating fluid recirculation system 106, a drying fluid circulation system 107, a regenerator 108 and a makeup heater 109.

The drying chamber 105 is bifurcated into spaced first and second portions 115 and 116. Material 102 to be dried is fed by a feeder 117 at the top of the chamber 105 into each of the portions 115 and 116 through which the material 102 descends principally due to gravity to a discharge apparatus 118 which controls the speed of descent of the material 102 through the chamber 105. Porous side walls 120 of each of the chamber portions 115 and 116 are formed of screen mesh, perforated metal or the like that allows the passage of a fluid, especially air, therethrough, but which maintains the material 102 in the chamber portions 115 and 116.

The chamber 5 outside the portions 115 and 116 is segregated into a series of stacked bays 114. In each bay 114 and located between the chamber portions 115 and 116 is a channel 125 that flow connects with adjacent areas of the chamber portions 115 and 116 through the porous side walls 120 in which fans 126 are mounted. The chamber portions 115 and 116 are also flow connected to exterior channels 130 through the outer side walls 120 and also with the fans 126 located in a cross channel 127. In this manner, the fans 126 create drying fluid flow through the material and associated channels 125, 127 and 126 in a continuous circulating loop in each bay 114.

The heating fluid system 106 comprises recirculation conduit 132 and a pump 133. The conduit 132 includes a first pipe 134 flow connecting the pump 133 with a tube side of the regenerator 108, a second pipe 135 flow connecting the regenerator 108 with the make up heater 109 and a third pipe 136 flow connecting the make up heater 109 to the chamber 105 at a bifurcation 137. At the bifurcation 137 a fourth pipe 139 flow connects with the third pipe 136 and follows a pathway downward through a majority of the chamber 105 with a serpentine loop 140 located at the intersection of the channels 125 and 127 such that the respective fans 126 urge gaseous drying fluid flow past the loops 140 so as to heat the gaseous drying fluid 155 from the heating fluid and therefrom heat the material 102 that the gaseous fluid recirculates through.

The fourth pipe 139 exits near the lower end of the chamber 105 and flow connects with the pump 133.

A fifth pipe 144 flow connects with the bifurcation 137 and enters the chamber 105 near the upper end thereof and in this embodiment where an upper two bays 146 out of a total of fifteen bays 146 are located, each bay 146 being associated with a fan 125 and respective channels 125, 127 and 130. The fifth pipe 144 also has respective serpentine loops 148 positioned to receive flow of gaseous fluid as circulated by the fan 126 in each upper bay 146. The fifth pipe 144 exits the chamber 105 near the upper end thereof and returns to the pump 133. Thus, the pump 133 pumps heating fluid generally counter flow to the material 102 in the two upper bays 146 and generally concurrent flow with the material 102 in the thirteen lower bays 114. The heating fluid is heated while passing through the regenerator 108 and make up heater 109 to a preselected temperature.

The drying fluid circulation system 107 draws drying fluid, which in this embodiment is ambient air in through an intake 150 located in the lower end of the chamber 105 utilizing a fan 151. The drying fluid flow is designated by arrows 155. The drying fluid 155 flows both in a recycle path through each bay 114 and 146 while passing through and heating the material 102 in a cross flow while also flowing upwardly through the lower thirteen bays 114 and exiting the chamber 105 through an outlet pipe 160. The outlet pipe 160 flow connects the drying fluid 155 with a shell side of the regenerator 108 wherein the drying fluid exchanges heat with and heats the heating fluid. The drying fluid 155 flows from the regenerator 108 through a discharge 162 and condensation collected in the regenerator 108 drains through a drain 163. While in the chamber 105 the drying fluid 155 removes moisture from the material 102 while becoming heated above the temperature thereof at the entrance into the chamber 105.

The drying fluid 155 also circulates through the material 102 in the top two bays 146; however, in the top two bays 146 the function of the drying fluid is only minimally to dry, but mainly to convey heat by convection from the heating fluid recirculation system to the material 102 so as to somewhat preheat and steep the material 102.

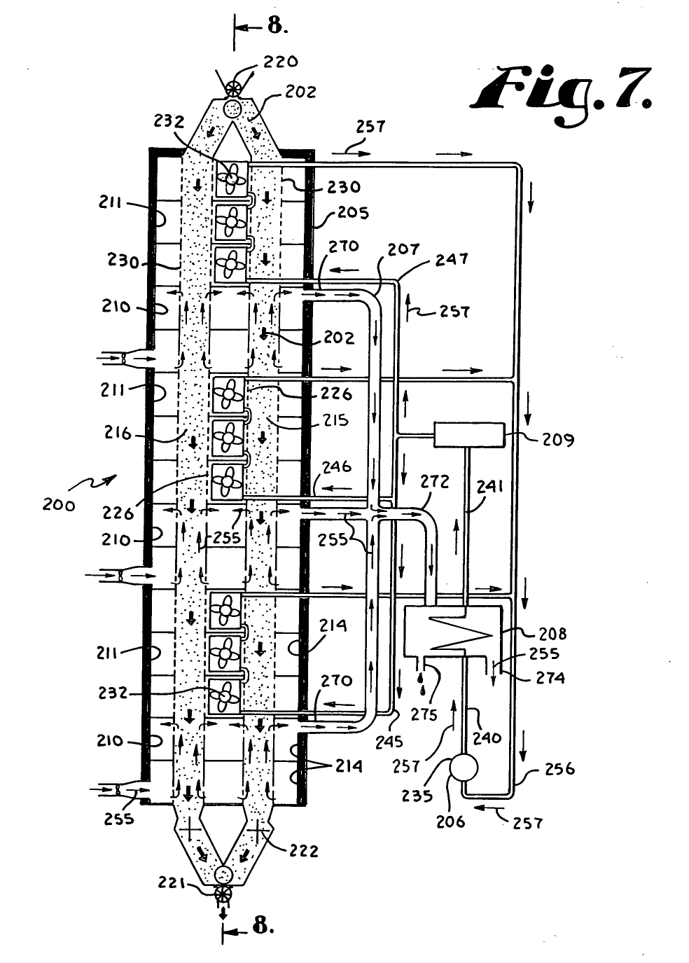

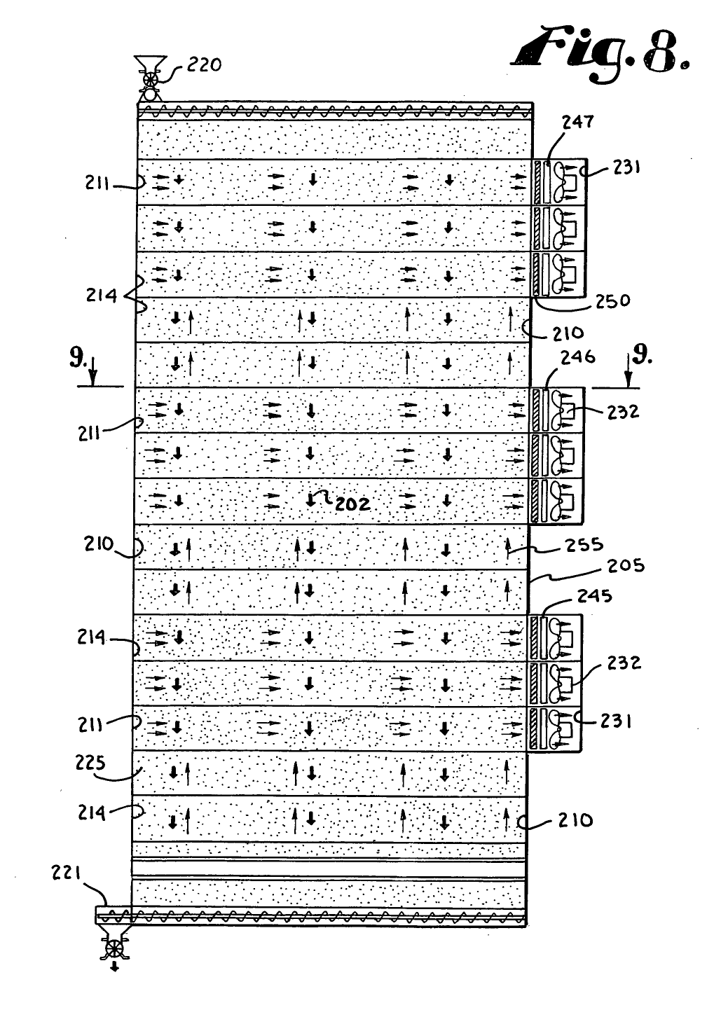

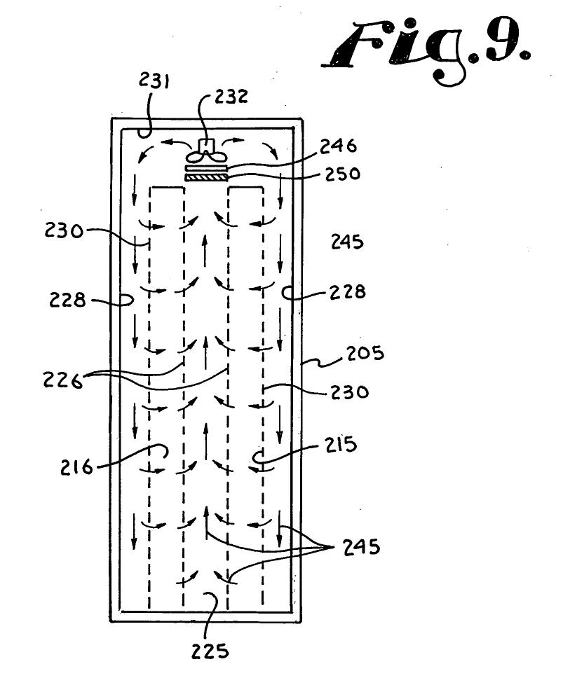

Illustrated in FIGS. 7, 8 and 9 is a third embodiment of a drier in accordance with the present invention generally indicated by the reference numeral 200 for drying a material 202 indicated by dots and dark flow arrows. The drier 200 includes a drying chamber 205, a heating recirculation system 206, a drying fluid circulation system 207, a regenerator 208 and a makeup heater 209.

The drier 200 differs from the previous drier 100 in that the steeping bays of the prior embodiment are not included and there are alternating heating and drying regions in drier 200.

In particular, the chamber 205 has alternating vertical regions with the lowest being a drying region 210, the next a heating region 211 and subsequent alternation of drying and heating regions 210 and 211. Each of the regions 210 and 211 include bays 214. There are two bays 214 in each drying region 210 and three bays 214 in each heating region 211.

The chamber 205 includes two spaced columns or portions 215 and 216 through which the material 202 flows after entering the chamber 215 through feed mechanism 220. The material 202 flows mainly due to gravity down through the chamber 205 under control of a discharge mechanism 221 and agitators 222.

Each bay 214 includes an inner channel 225 located between the portions 215 and 216 and separated therefrom by a porous divider wall or screen 226. An outer set of channels 228 is also separated from the material 202 in the chamber portions 215 and 216 by a porous divider wall or screen 230. The channels 225 and 228 are joined in the heating region bays 214 by a cross channel 231 within which a gaseous fluid driving fan 232 is located for circulating the fluid through the heating region bays 214 and the material 202 therein.

The heating recirculation system 206 includes a fluid pump 235 and an interconnected flow conduit 236. The conduit 236 includes a first pipe 240 flow joining the pump 206 to a tube side of a heat exchanger of the regenerator 208, a second pipe 241 joining the regenerator with the makeup heater 209 and a third pipe 242 discharging from the makeup heater 209 and splitting into three sub pipes 244, 245 and 246 each of which enter the chamber 205 in a heating region 211.

The sub pipes 244, 245 and 246 each circulate through each bay 214 in a respective heating region 211. The sub pipes 244, 245 and 246 each have serpentine regions 250 that are positioned to receive gaseous fluid flow from respective fans 232 which is heated thereby and in turn heats the material 202 as the drying fluid, represented by arrows 255, circulates in the bays 214 associated with the heating regions 211. The sub pipes 244, 245 and 246 join in pipe 256 and the heating fluid therein is returned to the pump 206. The heating fluid, as indicated by arrows 257, thus starts at the pump 206 relatively cool, is heated in the regenerator 208, is thereafter heated in the makeup heater 209 to a preselected temperature, for example 140 to 170° F. depending on the material 202 being dried, after which the heating fluid 257 enters the heating regions 211 and heats the gaseous drying fluid 255 therein which in turn heats the material 202. The heating fluid 257, at this point in a comparatively cooler state, for example 75°, returns to the pump 206.

The drying fluid 255, here gaseous and especially ambient air, enters the drying chamber 205 through multiple vertically spaced inlets 260 of the drying fluid recirculation system 207. Each of the inlets 260 is associated with a drying region 210 and in the illustrated embodiment there are three.

The drying fluid 255, initially at a comparatively cool temperature especially ambient temperature, for example 70° F., passes upward through the material 202 in respective drying regions 210 and then exits the chamber 205 through outlets 270 after the drying fluid 255 becomes warmer and at least partially saturated with moisture from the material 202. The exiting drying fluid 255, for example may be at 140° F., but the temperature can vary so as to be warmer or cooler depending upon the type of material 202 being dried. The outlets 270 are joined into a pipe 272 which flows into a shell side of the regenerator 208 wherein the drying fluid 255 heats the heating fluid 257 and exits an outlet 274. Condensate is drained from the regenerator 208 through a drain 275.

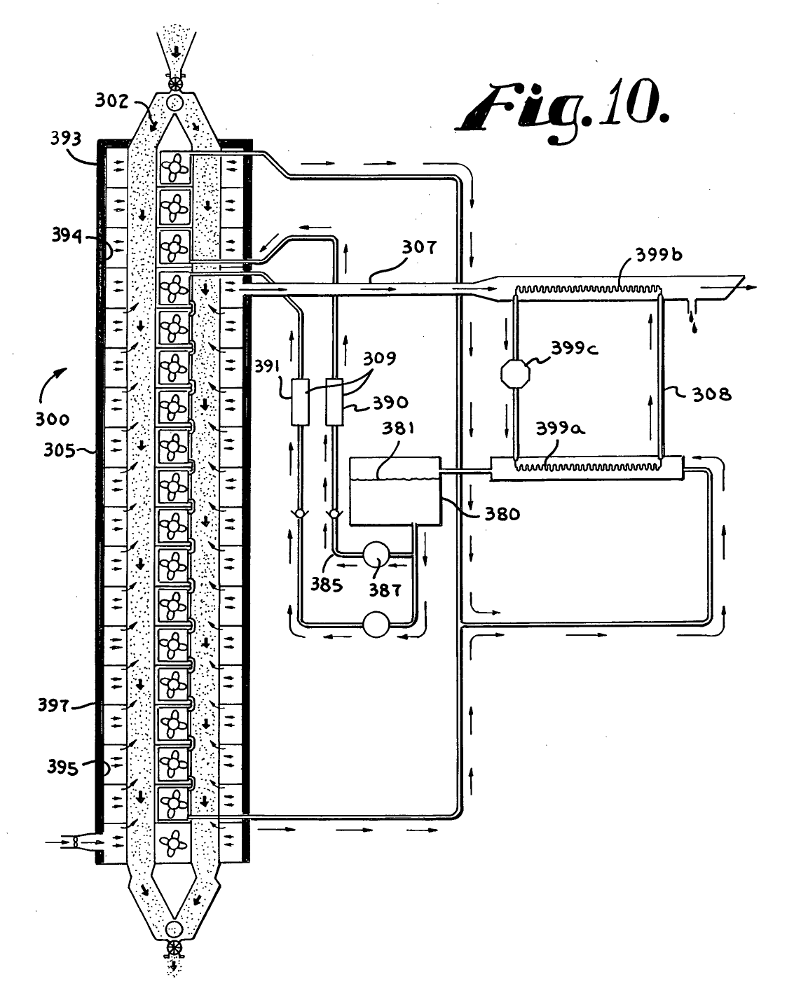

Shown in FIG. 10 is a fourth embodiment of a drier in accordance with the present invention generally indicated by the reference numeral 300 for drying material 302. The drier 300 includes a drying chamber 305, a heating fluid recirculation system 306, a drying fluid circulation system 307, a regenerator system 308 and a makeup heater system 309.

The drier 300 is similar in many respects to drier 100 so repetitive parts will not be described in detail and reference is made to drier 100 for greater explanation of common elements.

The drier 300 differs from drier 100 mainly in that the drier 300 uses a different regenerator 308 and a slightly different heat recirculation system 306.

The heat recirculation system includes a fluid reservoir 380 that holds excess heating fluid 381. Heating fluid piping 383 from the reservoir 380 diverges into sub pipes 385 and 386 each having a pump 387 and 388 and a makeup heater 390 and 391 respectively. The sub pipe 385 feeds the upper heating fluid requirements of a heating zone 393 (top three bays 394 of the chamber 305) and sub pipe 386 feeds remaining bays 395 of a lower drying zone 397.

In this manner, the heating fluid can be maintained at different temperatures at the entry to the zones 393 and 397. The heating fluid pipes 385 and 386 rejoin and return to the reservoir 381.

The regenerator 308 of this embodiment is generally a heat pump 398 as opposed to a tube and shell heat exchanger of drier 100. The heat pump 398 includes a condensing coil 399a for heating the heating fluid, an evaporator coil 399b for removing heat from the drying fluid after passage through the chamber 305 and a pump 399c for circulating heat pump fluid between the coils 399 a and b.

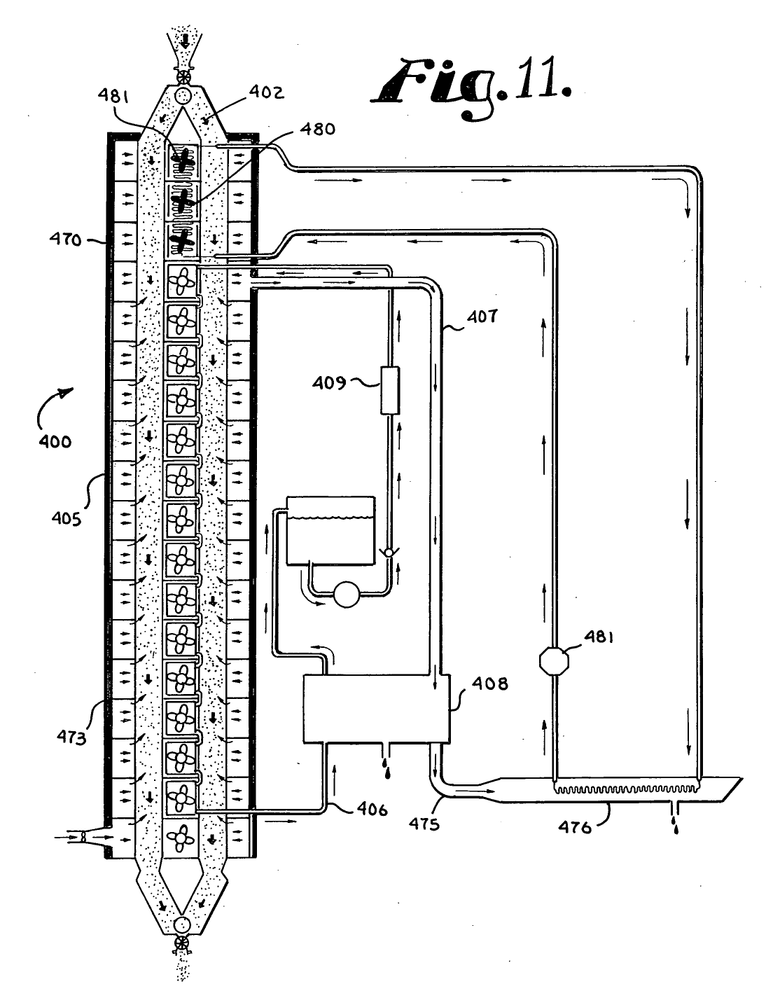

Shown in FIG. 11 is a fifth embodiment of a drier in accordance with the present invention generally indicated by the reference numeral 400 for drying a material 402. The drier 400 has a heating chamber 405, a heating fluid recirculation system 406, a drying fluid circulation system 407, a regenerator 408 and a makeup heater 409. Many aspects of the drier 400 are the same as driers 100 and 300, so certain redundant elements will not be discussed in detail, rather reference is made to the earlier driers 100 and 300 for additional explanation.

The drier 400 differs from the driers 100 and 300 principally with respect to the manner in which an upper heating zone 470 of the chamber 405 is heated and that the regenerator heat exchanger of drier 100 is supplemented or augmented by a heat pump system 472. The heat recirculating system 406 is utilized to circulate heating fluid through a lower combined heating and drying zone 473 of the chamber 405 and then through the regenerator 408 for partially reheating the heating fluid. The drying fluid exiting the regenerator 408 is conveyed by a pipe 475 to a second auxiliary regenerator 476 wherein an evaporator coil of the heat pump system 472 removes additional residual heat from the exhaust leaving the regenerator 408. The heat pump system 472 includes condensation coils 480 and a pump 481 for circulating fluid between the condensation coils 480 and the evaporator coil 476. The condensation coils 480 are placed in the circulating path of fans 481 so as to transfer heat from the fluid therein to the fluid being circulated in the heating zone 470 thereby preheating the material 402 from heat scavenged from the drying fluid exiting the regenerator 408. It is foreseen that a second heat pump could be used in place of the regenerator 408 to perform the same function.

FIG. 12 illustrates a sixth embodiment of a direr in accordance with the present invention generally designated by the reference numeral 500. The drier 500 has a chamber 505, a heating fluid recirculation system 506, a drying fluid circulation system 507, a regenerator 508, a makeup heater 509 and a heat pump system 572. The drier 500 is substantially equivalent in many aspects to driers 200 and 400 and other previous driers and attention is directed to the previous driers for description of additional detail that is not repeated with respect to this embodiment.

In this embodiment there is the option for multiple heating regions 570 and alternating multiple drying regions 571 as in drier 200 in the upper part of chamber 505. The lower part of the chamber 505 is similar to drier 300 wherein the heating fluid system 506 flows heated fluid through a plurality of bays 514 to heat the material 502 concurrently while drying fluid is conveyed by the drying fluid system 507 countercurrently relative to the material 502.

In the upper part of the chamber 505, the heat pump system 572 is utilized to heat material 502 in the heating regions 570 and drying fluid in passed through the drying regions 572. The heat pump system 572 removes residual heat from drying fluid exiting the regenerator 508. The present embodiment shows two pairs of heating and drying regions 570 and 572 in the upper part of the chamber 505 (one in solid lines and one in phantom lines), but the number can be increased as need be for the material 502 being dried and in view of the heat available from the heat pump system 572.

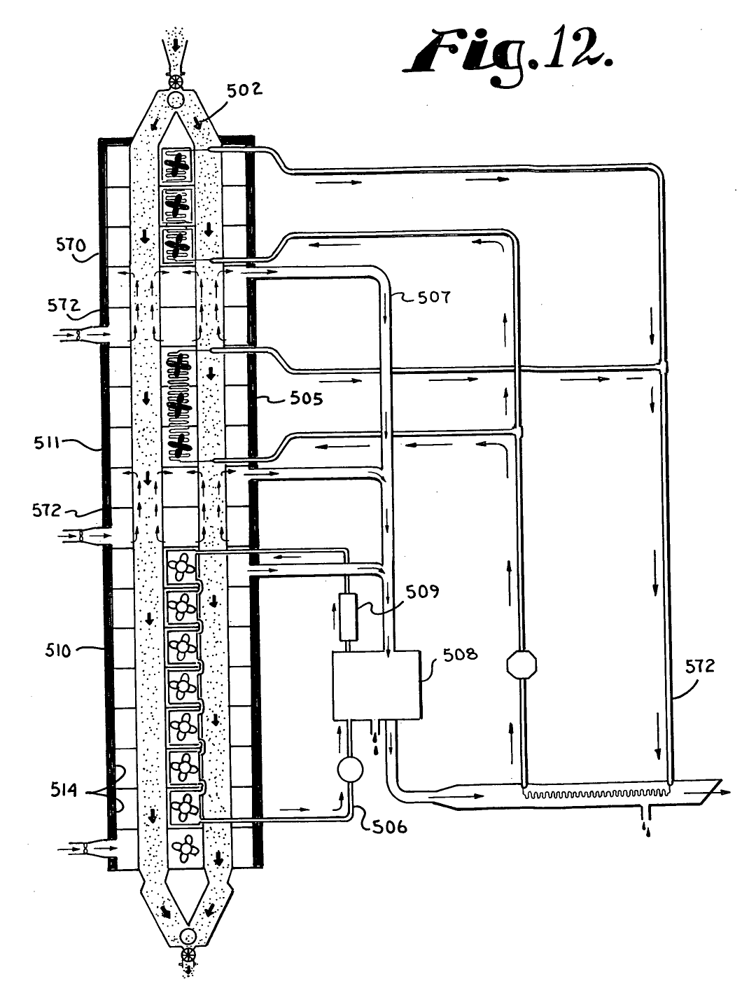

Shown in FIG. 13 is a seventh embodiment of a drier in accordance with the present invention generally designated by the reference numeral 600. The drier 600 includes a drying chamber 605, a heating fluid recirculation system 606, a drying fluid circulation system 607, a regenerator 608, a makeup heater 609 and an auxiliary heat pump system 672. The drier 600 is similar to drier 200 and includes elements shown in drier 400 as well as other previous driers, consequently elements previously shown and described will not be described in detail and reference is made to the earlier embodiments for greater detail.

In the drier 600 there are alternating heating regions 610 and drying regions 611 as in drier 200. The difference with drier 200 is that the heat pump system 627 removes residual heat from the drying fluid exiting the regenerator 680 and utilizes that heat to preheat the material 602 in the top heating region 610, as is done with drier 400.

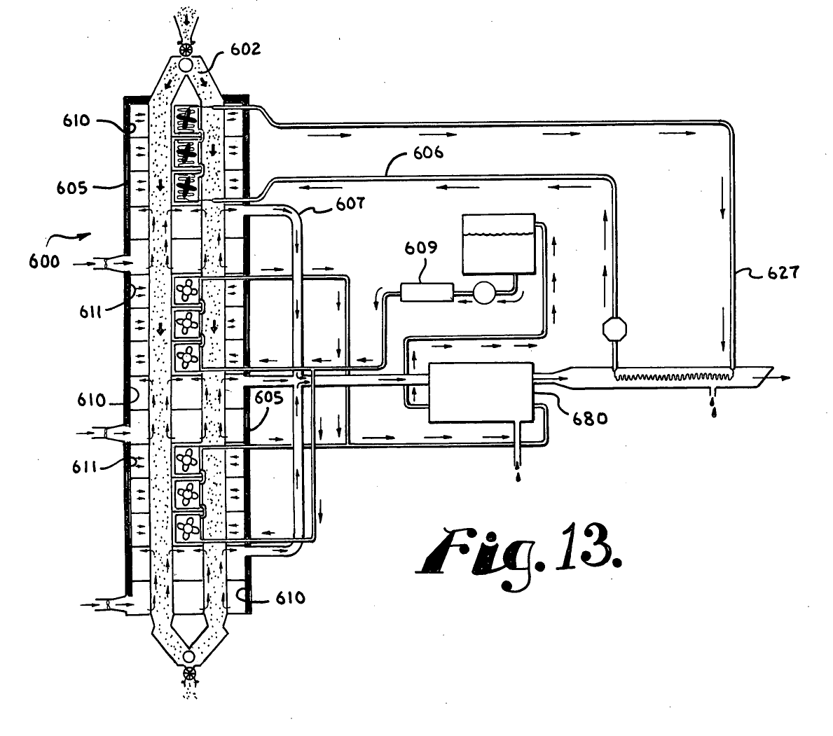

Illustrated in FIG. 14 is an eighth embodiment of a drier in accordance with the present invention that is indicated by the reference numeral 700. The drier 700 includes a drying chamber 705, a heating fluid recirculating system 706, a drying fluid circulation system 707, a regenerator 708, a makeup heater 709 and an auxiliary regenerating heat pump system 727. This drier 700 is similar to the previous drier 200 and other embodiments such that common details will not be repeated. Reference is made to the earlier embodiments for additional information.

In drier 700 there are multiple pairs of heating regions 711 and drying regions 710 that alternate. In a lower part 720 of the chamber 705 the heating fluid is supplied from the regenerator 708. In an upper part 721 of the chamber 705, the heating fluid is supplied from the heat pump system 727 that withdraws residual heat from drying fluid being discharged from the regenerator 708. As many heating region 711 and drying region 710 combination units may be utilized in the chamber 705 to make best use of the heat available from the regenerator 708 and the heat pump system 727

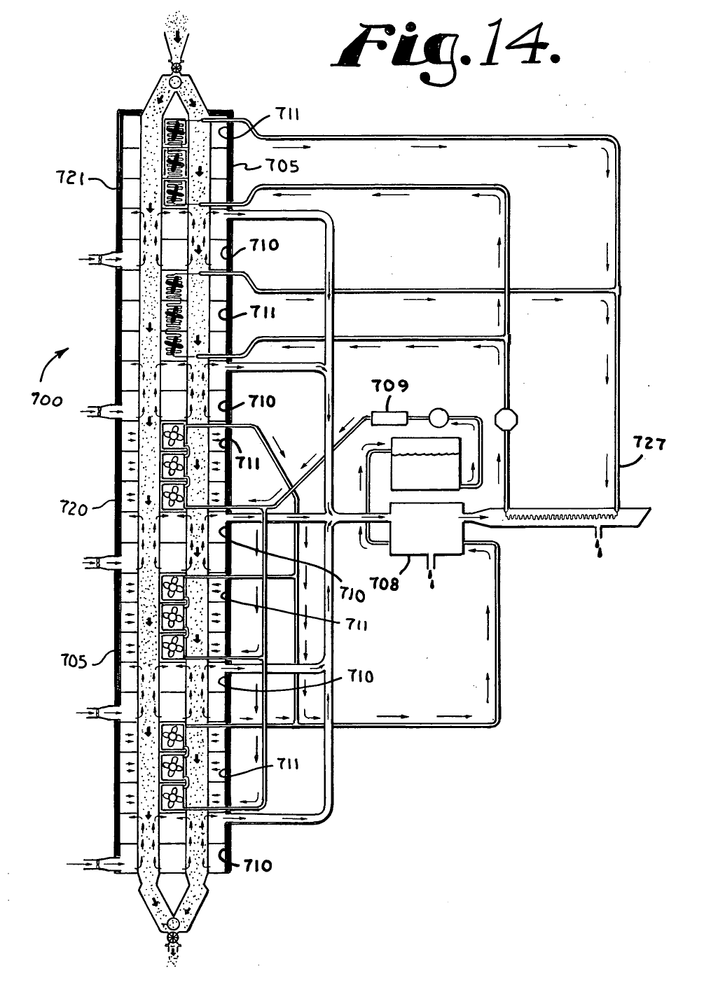

Illustrated in FIG. 15 is an eighth embodiment of a drier in accordance with the present invention that is indicated by the reference numeral 800. The drier 800 includes a drying chamber 805, a heating fluid system 806, a drying fluid system 807, a regenerator 808 and a makeup heater 809. This drier 800 is similar to the previous drier 200 and other embodiments such that common details will not be repeated. Reference is made to the earlier embodiments for additional information.

Drier 800 is similar to drier 200 except that instead of use of a tube and shell heat exchanger for the regenerator 808, a heat pump system 827 is utilized for this purpose. The heat pump system 827 has an evaporation coil 860 that removes heat from the drying fluid existing the chamber 805, a pump 861 that pumps fluid in the system 827 and a condensing coil 862 that transfers heat to the heating fluid that has exited the chamber 805. The heating fluid is thereafter used to heat material 702 in heating regions 711 that alternate with drying regions 710.

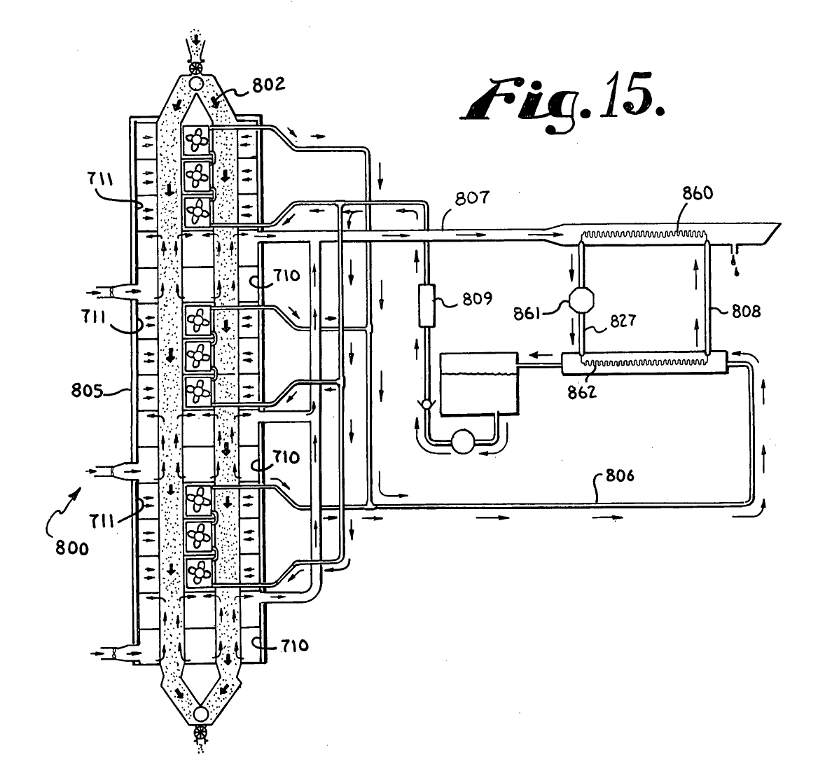

FIGS. 16, 17 and 18 are utilized to illustrate the concepts of having overall generally countercurrent flow, but having countercurrent, concurrent, cross or mixed flows within subregions.

FIG. 16 shows a drying chamber 900 having regions 901, 902 and 903. Flow of material is indicated by arrow 905 and flow of drying fluid is indicated by arrow 906. Within each region 901, 902 and 903 drying fluid flow 906 is concurrent with respect to material flow 905, but overall drying fluid flow 906 is countercurrent to material flow 905.

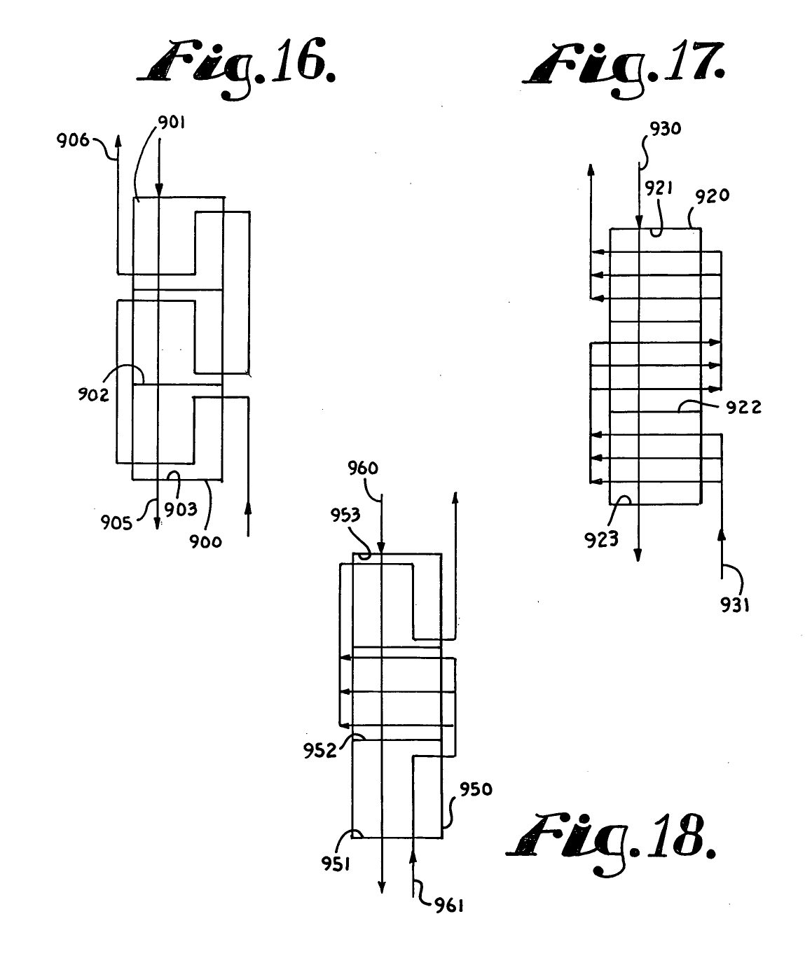

FIG. 17 shows a drying chamber 920 having regions 920, 921 and 922. Flow of material is indicated by arrow 930 and flow of drying fluid is indicated by arrow 931. Within each region 920, 921 and 922 drying fluid flow 931 is cross flow with respect to material flow 930, but overall drying fluid flow 931 is countercurrent to material flow 930.

FIG. 18 shows a drying chamber 950 having regions 951, 952 and 953. Flow of material is indicated by arrow 960 and flow of drying fluid is indicated by arrow 961. Within each region 951, 952 and 953 drying fluid flow 906 is countercurrent, cross and concurrent flow with respect to material flow 960, but overall drying fluid flow 960 is countercurrent to material flow 966.

It is to be understood that while certain forms of the present invention have been illustrated and described herein, it is not to be limited to the specific forms or arrangement of parts described and shown.

What is claimed and desired to be secured by Letters Patent is as follows:

1. A drier apparatus for drying a material utilizing a heating fluid and a drying fluid comprising:
a) a generally vertical drying chamber having upper and lower ends; the chamber being adapted to receive material to be dried at the upper end and discharge dried material at the lower end thereof;
b) a heating fluid recirculation system for operatively flowing the heating fluid generally concurrently with a flow of material through at least a portion of the chamber to transfer heat to said material while said material is within the chamber;
c) a drying fluid circulation system for operably flowing the drying fluid through at least a portion of the chamber generally overall counter current to the flow of the material in the chamber so as to become heated and at least partially saturated with vapor from the material;
d) a heating fluid regenerator operably receiving drying fluid in a heated state exiting from the chamber and heating fluid in a cool state exiting from the chamber in heat exchange relationship so as to preheat the heating fluid; and
e) a make up heater operably supplying makeup heat to the drier.

2. The drier apparatus according to claim 1 including:
a) the chamber includes an upper section wherein heating fluid flows generally countercurrent to the flow of material therein.

3. The drier according to claim 1 wherein:
a) the chamber includes alternating drying regions and heating regions with the heating fluid flowing only through the heating regions.

4. The drier apparatus according to claim 1 including:
a) a fluid conduit flow joining a drying fluid discharge end of said regenerator system with a drying fluid inlet of said drying region, so as to provide for recycling of the drying fluid; and
b) a heat removing device located in said fluid conduit adapted to cool the drying fluid passing through said fluid conduit to a preselected temperature.

5. The drier according to claim 1 wherein:
a) wherein at least part of the regenerator is a heat pump that is configured to return heat to be utilized by the drier.

7. The drier according to claim 3 wherein:
a) each heating region is divided into sub heating regions and said heating fluid recirculation system is configured in each sub heating region so that flow of the said heating fluid is selected from a group including concurrent, counter current, cross and mixed flows in each separate sub heating region while overall flow of heating fluid relative to said material is counter current through the heating region.

8. The drier according to claim 3 wherein:
a) each drying region is divided into sub drying regions and said drying fluid recirculation system is configured in each sub drying region so that flow of said drying fluid is selected from a group including concurrent, counter current, cross and mixed flows in each separate sub drying region while overall flow of drying fluid relative to said material is counter current through the drying region.

9. A method of drying a material comprising the steps of:
a) providing a drier with a vertical drying chamber;
b) passing the material through the chamber a top first end to a bottom second end thereof;
c) flowing a heating fluid initially in a heated state relative to said material in generally overall counter current flow relative to said material through at least a portion of the chamber and in heat transfer relationship with said material;
d) flowing in generally overall counter current flow relative to the material a drying fluid through at least part of the chamber in moisture and heat transfer relationship with the material, such that the drying fluid receives heat and moisture from the material and the drying fluid exits the drying region in a warm and wet state in comparison to entry of the drying fluid into the chamber and so that the material exits the chamber drier in comparison to entry of the material into the chamber;
e) withdrawing the heating fluid and the drying fluid from the chamber and thereafter utilizing the drying fluid to preheat the heating fluid;
f) thereafter returning the heating fluid in a heated state to the chamber to heat the material to be dried; and
g) adding make up heat to the drier for heat lost in the method.

10. The method according to claim 9 including the step of:
a) providing drying regions in the chamber wherein:
b) the heating fluid substantially bypasses the drying region.

11. The method according to claim 10 including:
a) providing a plurality of heating regions and paired drying regions; and
b) passing the material through all of the regions, the drying fluid through at least all of the drying regions and the heating fluid only through all of the heating regions.

12. The method according to claim 11 including:
a) flowing said drying fluid in each drying region in a flow selected from the group consisting of concurrent, counter current, cross and mixed flows through each individual drying region while flowing the drying fluid generally overall counter current through said drying region relative to said material.

13. The method according to claim 11 including:
a) flowing the heating fluid in each heating region in a flow selected from the group consisting of concurrent, countercurrent, cross and mixed flows through each individual heating region while flowing the heating fluid generally overall counter current through the heating region relative to the material.

14. The method according to claim 9 wherein:
a) withdrawing said heating fluid from near the chamber first end and withdrawing said drying fluid from near the chamber second end.

15. The method according to claim 9 including the step of:
a) collecting the drying fluid subsequent to utilizing the drying fluid to preheat the heating fluid and returning the collected drying fluid to the second end of the chamber.
